(19) United States
(12) Patent Application Publication
(10) Pub. No.: US 2003/0086852 A1
(43) Pub. Date: May 8, 2003

(54) Apparatus for the selective oxidation of carbon monoxide in a hydrogen-containing gas mixture

(75) Inventor: Patricia S.M. Chong, Burnaby (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Generation Systems Inc., Burnaby (CA)

(21) Appl. No.: 09/981,305

(22) Filed: Oct. 15, 2001

(51) Int. Cl. B01D 53/62

(52) U.S. Cl. 423/247; 422/211; 422/172; 422/177; 422/180; 422/190; 422/222; 423/246

(57) ABSTRACT

Selective oxidizers and methods of selectively oxidizing carbon monoxide in a hydrogen-containing gas mixture are provided. In one aspect, the present selective oxidizer assembly consists essentially of: a feed gas inlet for directing a feed gas comprising carbon monoxide and hydrogen into the assembly; an injector upstream of the feed gas inlet for supplying a gas stream comprising oxygen to the assembly; a catalyst bed for converting the feed gas and oxygen to a process gas, the catalyst bed comprising a selective oxidation catalyst on a metal foam support; and a process gas outlet.

### BACKGROUND OF THE INVENTION

1. Field of the Invention

The present invention relates to methods and apparatus for selectively oxidizing carbon monoxide in a feed gas. In particular, the present invention relates to a selective oxidizer assembly having a catalyst bed comprising a selective oxidation catalyst on a metal foam support.

2. Description of the Related Art

Fuel cell power plants operating on reformed hydrocarbon fuels typically include selective oxidizers to reduce the carbon monoxide (CO) in the feed gas (reformate) to levels acceptable for use in the fuel cells. The feed gas and small amounts of an oxygen-containing gas stream, such as air, are passed over a catalyst bed capable of selectively oxidizing CO in an exothermic reaction. The temperature in the selective oxidizer is maintained within a desired range to promote CO oxidation.

Commonly used selective oxidizer designs employ a single-stage assembly with heat exchangers of various types to maintain the catalyst bed within a temperature range required to produce the desired degree of CO oxidization. In addition, multiple air injection ports may be employed to inject oxygen at various points along the catalyst bed to moderate the rate of reaction along the bed profile and reduce the exotherm at the front of the bed. Examples of such selective oxidizer designs are described in PCT Application WO 00/32513, and U.S. Pat. Nos. 5,456,889 and 6,284,206 B1.

The requirement for heat exchange surfaces and systems for circulation of heat exchange fluids in such selective oxidizer designs undesirably increase their size, cost and complexity.

Other selective oxidizer designs approach the problem of temperature control by introducing interstage cooling, and a second adiabatic catalyst bed with at least a second air injector. Examples of this type of selective oxidizer are described in U.S. Pat. Nos. 5,330,727, 5,518,705, 5,750,076 and 5,853,674.

Obviously, this approach adds further heat exchangers and multiple stages of air injection and also undesirably increases the size, cost and complexity of the selective oxidizers.

Selective oxidizers usually employ pelletized catalyst beds. While such beds exhibit suitable catalytic activity, the pressure drop is relatively high. Typical pressure differentials for a 25-250 kW selective oxidizer pelletized bed are 7-21 kPa. For some applications, pressure differentials of more than 7 kPa are unacceptable.

Ceramic monoliths have been employed as a catalyst substrate for selective oxidizers. While ceramic monolith catalyst beds may exhibit a relatively low pressure drop, the poor thermal conductivity of ceramics tends to increase the need for heat exchangers and cooling fluids.

U.S. Pat. No. 6,284,206 B1 describes the use of metal foams for a selective oxidizer process gas flow fields. The selective oxidizer described in the '206 patent nonetheless employs a coolant fluid and heat exchange sections similar to other known selective oxidizer designs.

It would be desirable to provide a selective oxidizer assembly which is compact and less complex, and that is capable of operation without the need for heat exchangers. It would also be desirable to provide a selective oxidizer assembly that is capable of operation at lower pressure differentials.

### BRIEF SUMMARY OF THE INVENTION

A selective oxidizer assembly is provided. In one embodiment, the present selective oxidizer assembly consists essentially of:

(a) a feed gas inlet for directing a feed gas comprising carbon monoxide and hydrogen into the assembly;

(b) an injector upstream of the feed gas inlet for supplying a gas stream comprising oxygen to the assembly;

(c) a catalyst bed for converting the feed gas and oxygen to a process gas, the catalyst bed comprising a selective oxidation catalyst on a metal foam support; and

(d) a process gas outlet.

In another embodiment, the present selective oxidizer assembly includes a precooler upstream of the injector for supplying the feed gas to the feed gas inlet at a temperature at or above an ignition temperature of the catalyst.

In another embodiment of the present assembly, the metal foam support in the front portion of the catalyst bed a smaller pore size relative to the metal foam support in the rear portion.

In a further embodiment of the present assembly, the catalyst loading in the front portion of the catalyst bed is greater than the catalyst loading in the rear portion of the bed.

A method of selectively oxidizing carbon monoxide to carbon dioxide is also provided. In one embodiment, the method comprises:

(a) supplying a feed gas comprising carbon monoxide and hydrogen to an assembly consisting essentially of

a feed gas inlet for receiving the fuel gas,

an injector upstream of the feed gas inlet,

a catalyst bed comprising a selective oxidation catalyst on a metal foam support, and

a process gas outlet; and

(b) supplying a gas stream comprising oxygen to the injector.

### BRIEF DESCRIPTION OF THE SEVERAL VIEWS OF THE DRAWING(S)

FIG. 1 is a plot of CO conversion against O₂:CO ratio for selective oxidizer assemblies employing the pelletized and ceramic monolith beds.

FIG. 2 is a plot of CO conversion against O₂:CO ratio for selective oxidizer assemblies employing pelletized and knitted stainless steel mesh beds.

FIGS. 3 and 4 are plots of CO conversion against O₂:CO ratio for selective oxidizer assemblies employing a pelletized bed and embodiments of the present selective oxidizer assembly.

FIG. 5 is a plot of the temperature profile for a selective oxidizer assembly employing a pelletized bed and embodiments of the present selective oxidizer assembly.

FIG. 6 is a plot of CO conversion against O₂:CO ratio for a selective oxidizer assembly employing a pelletized bed and embodiments of the present selective oxidizer assembly having differing bed heights.

FIG. 7 is a plot of bed pressure drop against air flow rate for a selective oxidizer assembly employing a pelletized bed and embodiments of the present selective oxidizer assembly.

### DETAILED DESCRIPTION OF THE INVENTION

The following reactions occur in a selective oxidizer:

1. The desired oxidation of carbon monoxide to carbon dioxide:

2CO+O₂ [symbol] 2CO₂ (1)

2. The undesired oxidation of hydrogen to water:

2H₂+O₂ [symbol] 2H₂O (2)

3. The undesired reverse water gas shift reaction:

CO₂+H₂ [symbol] H₂O+CO (3)

Typical operating temperatures are within a range of about 75° C. to about 180° C.

At lower temperatures (roughly 95° C.-150° C.), the oxidation of CO (1) is favored. As the temperature increases above 150° C., reactions (2) and (3) are favored. Thus, higher CO conversion rates are favored at lower temperatures.

CO conversion rates are also influenced by oxygen concentration, often expressed as the O₂:CO excess ratio. For example, if the O₂:CO ratio is too low or the catalyst bed is oversized, oxygen can be substantially consumed along the length of the bed. Oxygen-depleted conditions also favor the reverse water gas shift reaction (3), and negatively impacts CO conversion rates.

While CO conversion rates are higher at lower temperatures, catalytic activity increases at higher temperatures. Higher catalytic activity permits the use of a smaller bed volume, which can be a significant cost benefit. Thus, the choice of bed size and operating temperature generally reflects a balance between cost and CO conversion rate. Typically, other parameters such as catalyst loading, bed space velocity (Sv), and O₂:CO ratio (usually air flow), are also selected to control the temperatures in the bed so that the bed size is minimized while maximizing CO conversion rates.

In fuel cell applications in particular, the aim is to achieve as high a rate of CO conversion as reasonably possible. Preferably, the reformate stream exiting the selective oxidizer assembly has a CO content of about 10 ppm or less.

As mentioned previously, conventional selective oxidizers employ heat exchangers and/or multiple air injectors to moderate temperatures in the catalyst bed. Indeed, two-stage selective oxidizers typically employ two catalyst beds and interstage cooling between them, as well.

In one embodiment, the present selective oxidizer assembly is a single stage, adiabatic assembly capable of operation without heat exhangers to control the temperatures in the catalyst bed. The present selective oxidizer assembly employs a catalyst bed comprising a selective oxidation catalyst on a metal foam support.

Without being bound by theory, it is believed that the porosity and thermal conductivity of the metal foam support in the present selective oxidizer assembly assists in moderating the CO oxidation reaction throughout the bed, and assists in maintaining a larger portion of the bed at lower temperatures where conditions favor CO oxidation. By employing a metal foam support with a suitable pore size and thermal conductivity, the present selective oxidizer assembly does not require heat exchangers for temperature control.

In another embodiment of the present selective oxidizer assembly, the metal foam support in the front end of the catalyst bed has a smaller pore size relative to the metal foam support in the rear portion. The reaction may light off earlier in the front portion of the bed, while the larger pore size metal foam in the remainder of the bed may moderate the consumption of oxygen and maintain the bed temperature within the selectivity range for CO oxidation. This can provide for a more efficient use of the bed volume, and may allow for a reduction in the volume of the bed without a corresponding reduction in Sv.

In yet another embodiment of the present selective oxidizer assembly, the catalyst loading at the front end of the bed is greater than the catalyst loading in the remainder of the bed. The increased catalyst loading in the front portion of the bed may cause the reaction to light off earlier in the front portion of the bed, and may increase bed efficiency, as discussed above.

The metal foam support of the present selective oxidizer assembly may comprise suitable metals and/or metal alloys. The metal foam support should be selected with a suitable thermal conductivity and be stable under the normal operating conditions. Suitable thermal conductivity of the metal foam support for a given application will depend on such factors as the size of the catalyst bed, the pore size of the metal foam support, the concentration of CO in the feed gas stream, the operating temperature of the assembly, and the desired output. Persons skilled in the art can select a suitable metal foam support for a given application by routine experimentation.

Typically, the selective oxidation catalyst will comprise a supported platinum catalyst. The catalyst may be applied to the metal foam support with a conventional wash coat, for example. However, the selection of selective oxidation catalyst, and the method of applying it to the metal foam support, are not essential to the present selective oxidizer assembly, and persons skilled in the art may select a suitable catalyst composition and method of applying it to the support for a given application.

The present selective oxidizer assembly may have a single point of air injection, or it may employ multiple injectors, if desired.

The temperature of the feed gas supplied to the present selective oxidizer assembly should be above the dew point of the feed gas and may be at a minimum temperature required for suitable catalytic activity. The feed gas can be supplied to the present selective oxidizer assembly at higher temperatures, if desired, but lower inlet temperatures may assist in maintaining the bed temperature within the selectivity range for CO oxidation. For example, the feed gas may be provided to the present selective oxidizer assembly at or above ignition temperature. Ignition temperature refers to the minimum temperature at which a catalytic reaction will self-ignite in the presence of a catalyst.

In another embodiment, the present selective oxidizer assembly further comprises an upstream precooler for cooling the feed gas to a temperature at or above an ignition temperature for the selective oxidation catalyst that is above the dew point of the feed gas. For example, the precooler could receive reformate from an upstream shift assembly, where the outlet temperatures can exceed 300° C., and cool it by heat exchange to a temperature between about 100° C. and about 130° C.

The following examples are for purposes of illustration and are not intended to limit the invention. COMPARATIVE EXAMPLE 1

The CO conversion as a function of the O₂:CO ratio (ER) was compared for selective oxidizer assemblies employing catalysts on the following supports:

1. Selectoxo™ pellets (Engelhard, Iselin, N.J.);

2. Selectra™ ceramic monolith (Engelhard, Iselin, N.J.) of 3 different cell sizes—400 cpsi, 600 cpsi, and 900 cpsi; and

3. Knitted mesh, made from 304 stainless steel (4, 7 and 12 strands per inch), obtained from Amistco Separatio Products, Inc. (Alvin, Tex.).

Supports 2 and 3 were wash coated with substantially the same selective oxidation catalyst present on the Selectoxo™ pellets (0.3% Pt on y-alumina and metal oxide support).

Each catalyst was placed in a simple adiabatic vessel 7.5 cm in length and having an inner diameter of 2.5 cm to produce a test selective oxidizer assembly. The flow conditions employed were as follows:

| | |
|---|---|
| system pressure: | 14 kPa (gauge) |
| Sv: | 5400 l/h |
| feed gas: | 2700 ppm CO; 18% CO₂; 38% H₂O; 50% H₂ |
| inlet temperature: | 113° C. |

The air flow was varied to measure the CO conversion at incremental O₂:CO ratio values. The concentration of CO in the product gas stream exiting the assemblies was determined with an IR sensor, and this value was used to determine the CO conversion rate. The performance of each of the selective oxidizer assemblies employing the monolithic supports was compared to the selective oxidizer assembly employing Selectoxo™ pellets as a baseline.

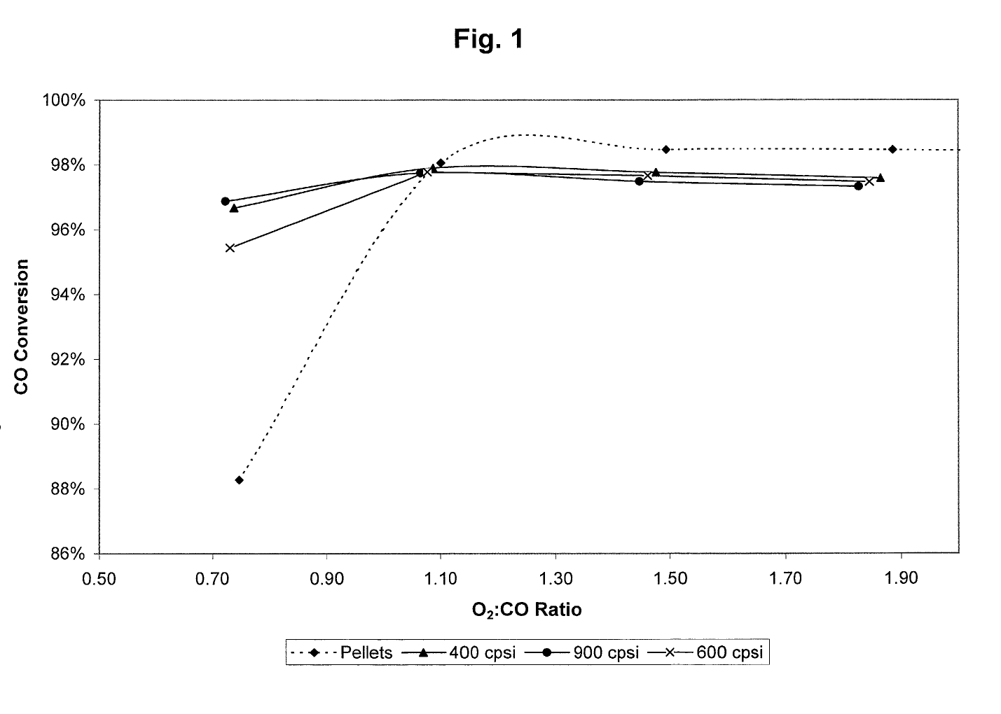

FIG. 1 is a plot of CO conversion against O₂:CO ratio for the selective oxidizer assemblies employing the Selectoxo™ pellets and Selectra™ ceramic monoliths. As shown in FIG. 1, there is negligible difference in CO conversion between the ceramic monoliths. The ceramic monoliths yielded slightly lower conversion rates than the pellets at the higher O₂:CO ratio values, but much higher conversion rates at the lower O₂:CO ratio value.

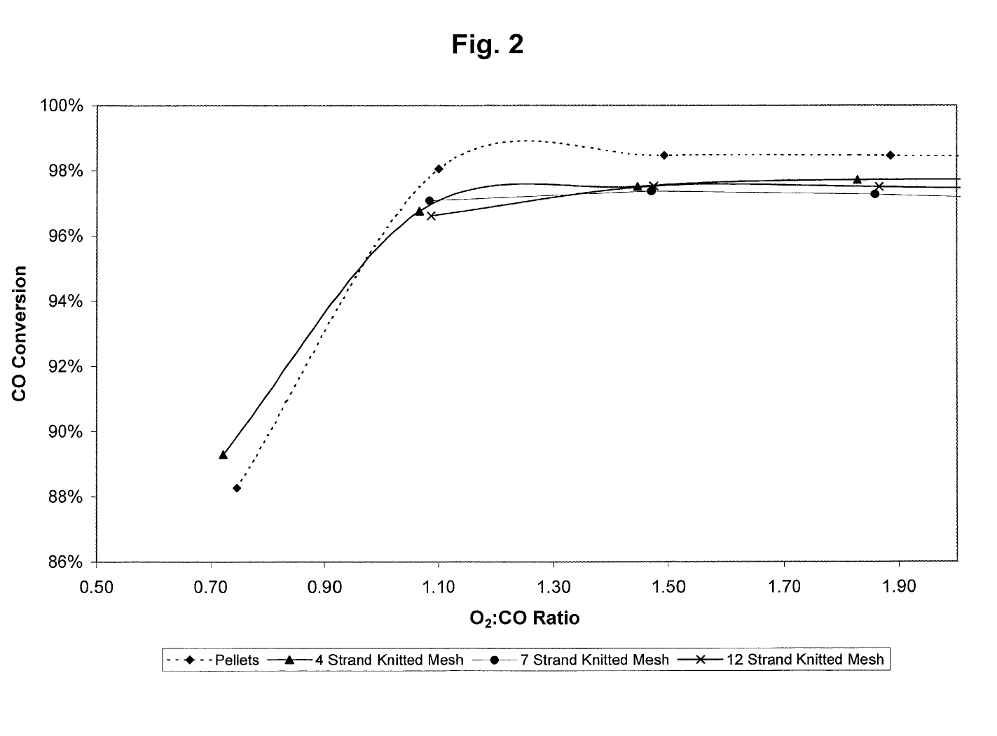

FIG. 2 is a plot of CO conversion against O₂:CO ratio for the selective oxidizer assemblies employing the Selectoxo™ pellets and knitted stainless steel mesh supports. As shown in FIG. 2, there is little difference in CO conversion between the knitted mesh supports. The performance against the pellets is also similar, although the conversion rates are slightly less at the higher O₂:CO ratio values.

Note that there is little difference in performance at higher CO conversion rates between the catalyst pellets and either the ceramic monolith or knitted mesh catalysts. Indeed, the pellets exhibit greater selectivity (i.e., higher CO conversion rates at lower O₂:CO ratio) above 98% conversion, and have higher maximum conversion rates, than either the ceramic or knitted mesh catalysts.

### EXAMPLE 2

The CO conversion as a function of the O₂:CO ratio was compared for a selective oxidizer assembly employing Selectoxo™ pellets and embodiments of the present selective oxidizer assembly.

Metal foam supports (2.5 cm diameter) were obtained from Porvair (Norfolk, UK) in 3 different pore sizes: 10 ppi (pores per linear inch), 20 ppi and 40 ppi. Each metal foam is made from an FeCrAlY alloy having a porosity of 95%. The supports were wash coated with catalyst, as described in Example 1, above.

Selective oxidizer assemblies using Selectoxo™ pellets and the catalysed metal foam supports were constructed and tested as described in Example 1, above. The metal foam supports were wrapped in insulation to prevent gas slippage and then stacked within the vessel.

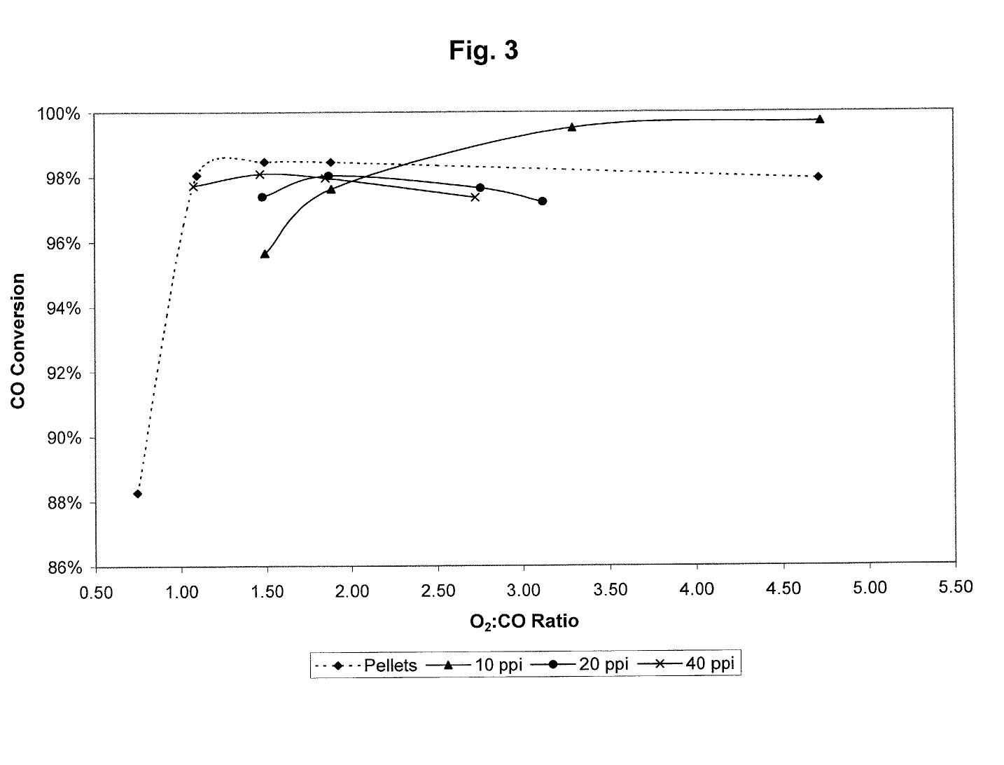

FIG. 3 is a plot of CO conversion against O₂:CO ratio for the selective oxidizer assembly employing the Selectoxo™ pellets and the embodiments of the present selective oxidizer assembly. As shown in FIG. 3, the 20 ppi and 40 ppi metal foams performed similarly to the pellets, although the conversion rates were slightly less. The 10 ppi metal foam yielded the highest conversion rate (>99.5%) of the catalyst supports tested, at higher O₂:CO ratio.

### EXAMPLE 3

The CO conversion as a function of the O₂:CO ratio, at higher Sv, was compared for a selective oxidizer assembly employing Selectoxo™ pellets and embodiments of the present selective oxidizer assembly.

Each catalyst was placed in a simple adiabatic vessel having an inner diameter of 4.30 cm. The pellets were packed in the vessel. Metal foam supports (4.30 cm diameter) were prepared as described in Example 2, above. The metal foam supports were wrapped in insulation to prevent gas slippage and then stacked within the vessel. The bed height of each bed was 26.7 cm. Thermocouples were inserted along the length of the catalyst beds to measure the temperature profile.

The flow conditions employed were:

| | |
|---|---|
| system pressure: | approx. 380 kPa (gauge) |
| feed gas: | natural gas reformate; 2.75 steam:carbon ratio |
| feed gas flow rate: | 0.06 gmol/s |
| air flow rate: | 3.0 × 10⁻³ gmol/s to 1.2 × 10⁻² gmol/s |
| Sv: | 70,000 l/h |
| inlet temperature: | 107° C. |

A baseline was established using the Selectoxo™ pellets. The CO conversion was measured as a function of air flow rate at three different CO(in) concentrations: 1700 ppm, 2100 ppm and 2400 ppm. The concentration of CO in the product gas stream exiting the assemblies was determined with an IR sensor, and this value was used to determine the CO conversion rate. The same test was repeated with the three different foams at the same Sv.

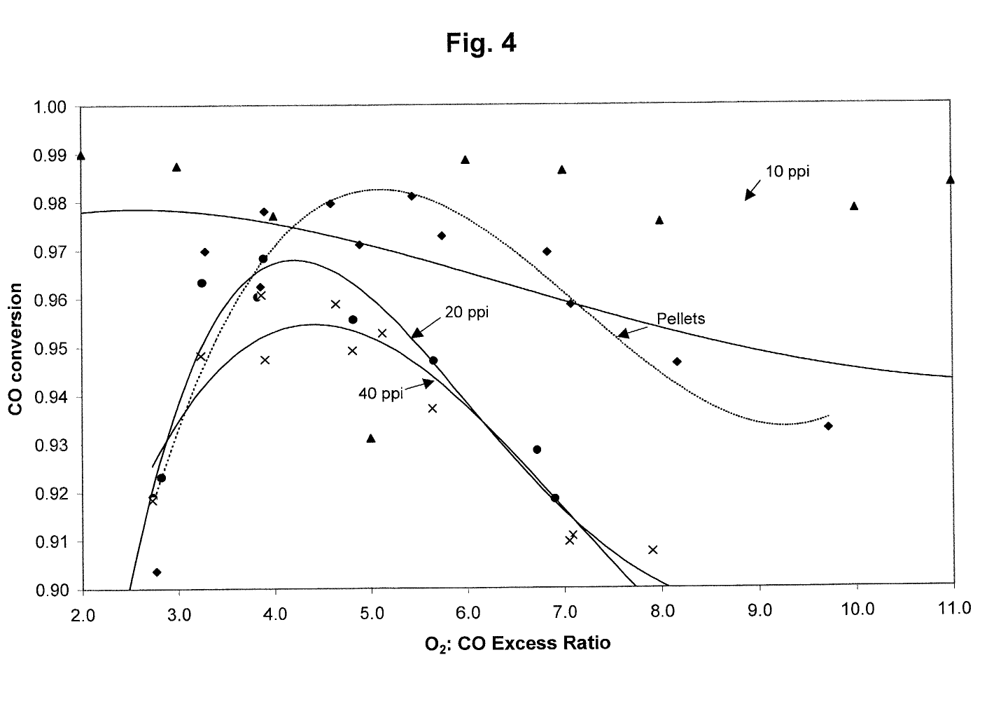

FIG. 4 is a plot of CO conversion against O₂:CO ratio for the selective oxidizer assembly employing the Selectoxo™ pellets and the embodiments of the present selective oxidizer assembly. As shown in FIG. 4, the baseline pellets gave the highest selectivity (i.e., lowest O₂:CO ratio) for 98% CO conversion, but the 10 ppi metal foam support gave the highest CO conversion at 99%, at slightly higher O₂:CO ratio. Although the 20 ppi and 40 ppi metal foam supports yielded lower conversion rates, their optimum O₂:CO ratio were low, suggesting that the 20 ppi and 40 ppi beds may be oversized.

Note also that the 10 ppi metal foam bed is less sensitive to the optimum CO conversion and O₂:CO ratio than the other beds. The insensitivity to CO conversion has an important advantage when developing air flow strategy, as precise control of the O₂:CO ratio in the present selective oxidizer assembly is less critical.

### EXAMPLE 4

The temperature profiles of each of the selective oxidizer assemblies of Example 3 were plotted under flow conditions similar to those described in Example 3, above, except that the CO(in) concentration was 2400 ppm and the air flow rate was 0.01 gmol/s.

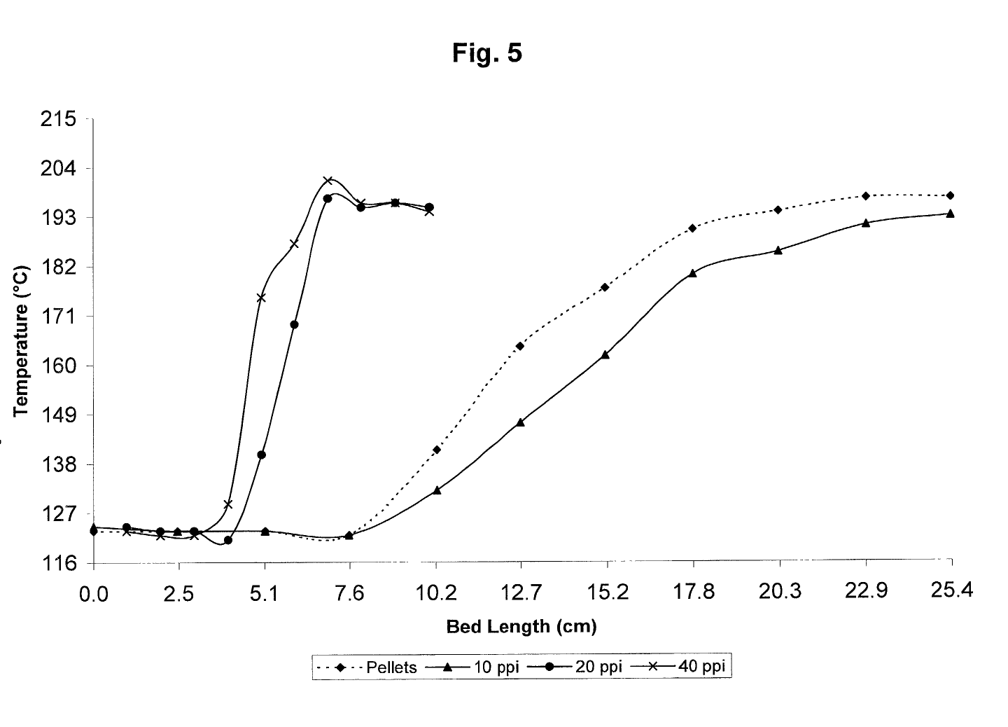

FIG. 5 is a plot of the temperature profile for the selective oxidizer assembly employing the Selectoxo™ pellets and the embodiments of the present selective oxidizer assembly. As shown in FIG. 5, the present selective oxidizer assembly containing the 10 ppi metal foam support consumes oxygen throughout the entire bed, whereas in the embodiments containing the 20 ppi and 40 ppi metal foam supports the oxygen is essentially consumed at 17-18 cm. When an adiabatic selective oxidizer bed is oversized, and the oxygen is consumed part way through the bed, the conditions may be right for the reverse water gas shift reaction (3) if the bed temperature exceeds about 175° C. This condition negatively impacts CO conversion, and likely was present in the 20 ppi and 40 ppi beds. Thus, FIG. 5 further supports the hypothesis that the 20 ppi and 40 ppi beds are oversized and that this may explain the lower CO conversion rates observed in Example 3 (see FIG. 4).

The key to selectivity in selective oxidizers is high catalyst activity at low temperatures, where reaction conditions favor the oxidation of CO. At the same time, it is important to moderate the reaction so that the oxygen is not completely consumed part way through the bed. As shown in FIG. 5, in the present selective oxidizer assembly containing the 10 ppi metal foam support, the reaction is moderated throughout the bed, and a larger portion of the bed is at lower temperatures where reaction conditions are selective for CO oxidation.

FIG. 5 also indicates that in the present selective oxidizer assemblies containing 20 ppi and 40 ppi metal foam supports, the reactions lights off earlier in the bed relative to both the 10 ppi metal foam support and the catalyst pellets. This suggests that in embodiments of the present selective oxidizer assembly where the pore size of the metal foam support is smaller in the front portion of the bed relative to the back portion, the reaction may light off quickly and may increase bed efficiency. For example, the front end of the bed may comprise 20 ppi or 40 ppi metal foam, with 10 ppi metal foam in the remainder of the bed.

### EXAMPLE 5

The CO conversion as a function of the O₂:CO ratio was compared for a selective oxidizer assembly comprising Selectoxo™ pellets, and embodiments of the present selective oxidizer assembly employing the catalyst coated 20 ppi metal foam described in Example 3, above.

The pelletized bed and one of the 20 ppi metal foam beds (bed A) were prepared as described in Example 3, above. The other 20 ppi metal foam bed (bed B) was prepared in the same manner, except that the bed length was shortened to 17.8 cm.

The same flow conditions were employed as described in Example 3, above, so that the pelletized bed and bed A had an Sv=70,000 1/h. The shorter length of bed B yielded an Sv=100,000 1/h.

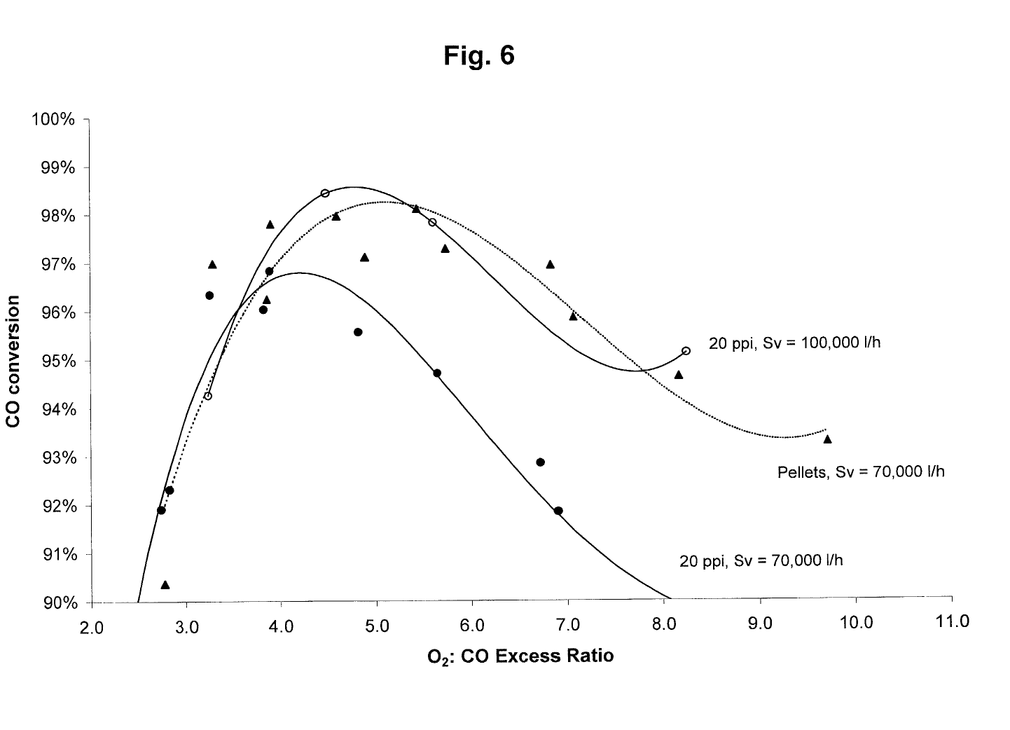

FIG. 6 is a plot of CO conversion against O₂:CO ratio for the selective oxidizer assembly employing the Selectoxo™ pellets and the embodiments of the present selective oxidizer assembly. As expected, FIG. 6 confirms that the 20 ppi metal foam support bed at Sv=70,000 1/h is oversized (bed A). The CO conversion and O₂:CO ratio of bed B, however, is improved at Sv=100,000 1/h. Indeed, the performance of bed B at Sv=100,000 1/h is comparable to that of the pelletized bed at Sv=70,000 1/h. This indicates that the Sv of the present selective oxidizer assembly is improved by more than 40% relative to the conventional pelletized bed.

### EXAMPLE 6

The thermal response of each of the selective oxidizers of Example 3 was determined by measuring the time required for each bed to reach a steady state after a step change in the air flow rate. The flow conditions used were similar to those described in Example 3, above, except that the CO(in) concentration was 2400 ppm and the air flow rate was increased stepwise from 4.0×10⁻³ gmol/s to 7.0×10⁻³ gmol/s. The results of the test are summarized in Table 1.

TABLE 3

| | | | | Air flow | | |
|---|---|---|---|---|---|---|
| Catalyst | T₍ᵢₙᵢₜᵢₐₗ₎ | T_{(final)} | dT | increase | Time | Rate |
| support | (° C.) | (° C.) | (° C.) | (gmol/s) | (sec) | (° C./min) |
| Pellets | 148 | 176 | 28 | 3.0 × 10⁻³ | 207 | 8.1 |
| 10 ppi metal | 147 | 169 | 22 | 3.0 × 10⁻³ | 38 | 34.7 |
| foam | | | | | | |
| 20 ppi metal | 149 | 172 | 23 | 3.0 × 10⁻³ | 20 | 69.0 |
| foam | | | | | | |
| 40 ppi metal | 149 | 173 | 24 | 3.0 × 10⁻³ | 50 | 28.8 |
| foam | | | | | | |

As indicated in Table 1, the selective oxidizer assembly with the conventional pelletized bed requires at least 4-10 times longer to reach steady state than the embodiments of the present selective oxidizer assembly. The faster thermal response of the present selective oxidizer assembly has advantages in applications where a fast start-up is required, and/or in load following applications where the output of the selective oxidizer assembly varies during operation.

### EXAMPLE 7

The pressure drop (dP) as a function of bed height and air flow rate was compared for selective oxidizers employing Selectoxo™ pellets and embodiments of the present selective oxidizer assembly.

The selective oxidizer assemblies were made as described in Example 3, above, except that the height of each bed was approximately 10 cm.

The pressure drop tests were conducted using air. The flow rate of air was varied at 0.10, 0.20 and 0.40 gmol/s. A back pressure of approximately 50 kPa (gauge) was maintained during each test. The pressure drop was measured using a water manometer. The pressure drop through the empty vessel was also measured and substracted from the total measured pressure drop to calculate the pressure drop of the catalytic bed. The air velocity through the bed was measured by a rotameter. Air flow velocity is directly proportional to flow rate, since the cross-sectional flow area is the same for each test.

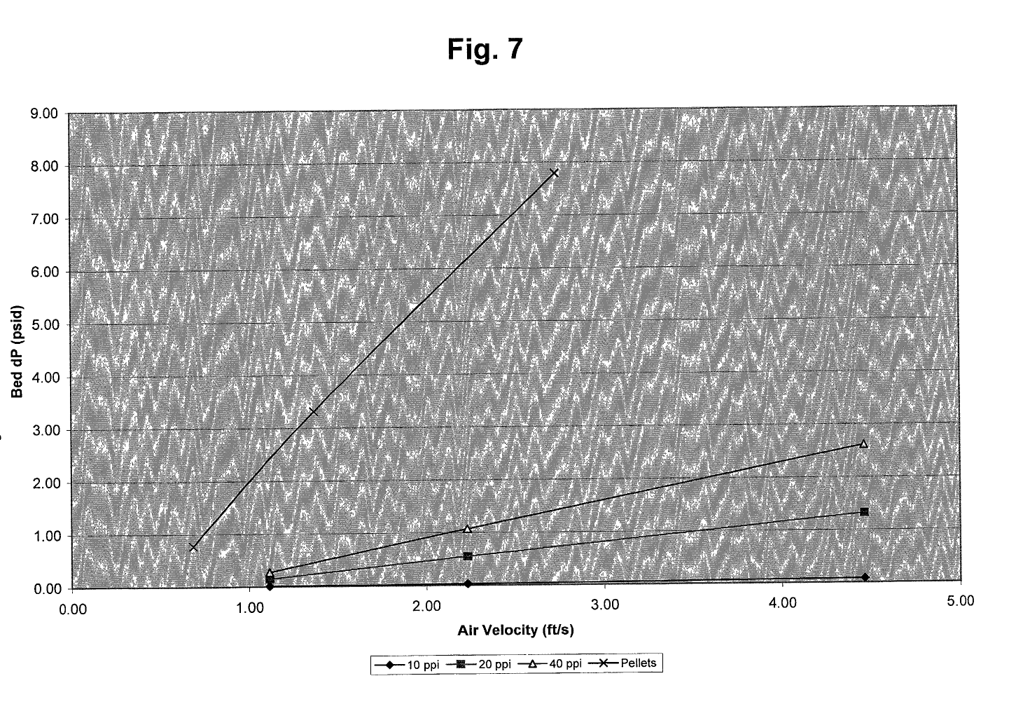

FIG. 7 is a plot of bed dP against air velocity for the selective oxidizer assembly employing the Selectoxo™ pellets and the embodiments of the present selective oxidizer assembly. As FIG. 7 clearly illustrates, the pressure drop through the catalyst beds in the embodiments of the present selective oxidizer assembly is at least ½ to about ⅙ lower than the pressure drop through the pelletized catalyst bed. A lower pressure drop through the catalyst bed may assist in reducing parasitic losses associated with pressurizing the feed gas and/or air.

As shown above, ceramic monoliths and knitted mesh supports do not offer any advantages over pelletized beds insofar as CO conversion rates are concerned. Further, it is believed that the poor thermal conductivity of ceramic supports prevent them from moderating temperatures in the catalyst bed without heat exchangers.

Even in U.S. Pat. No. 6,284,206 B1, which describes a selective oxidizer assembly having catalyzed process gas flow fields formed from ceramic or metal foam components, the ability of metal foam supports to moderate the temperatures of the catalyst bed is not recognized; heat exchangers are required for the selective oxidizer assembly of the '206 patent.

The present selective oxidizer assembly, however, can operate as a single stage, adiabatic assembly without the need for heat exchangers to moderate catalyst bed temperatures. It may employ a single point of air injection. It is simpler and may be less costly compared to conventional designs.

Additionally, the Sv of the present selective oxidizer assembly demonstrates an improvement of more than 40% relative to conventional pelletized beds. This may permit the use of smaller assemblies for a given output.

The present selective oxidizer assembly also operates at a lower pressure drop, and has an increased thermal response, relative to conventional pelletized beds. As mentioned above, these characteristics can have advantages in applications where a fast start-up is required, and/or in load following applications where the output of the selective oxidizer assembly varies during operation. From a systems perspective, parasitic losses from compressors and/or heaters may also be reduced.

In comparison to conventional selective oxidizers, the present oxidizer assembly comprising the 10 ppi metal foam support also demonstrated a higher maximum CO conversion rate and a decreased sensitivity to the O₂:CO ratio. These characteristics can provide further significant advantages in terms of assembly efficiency and fuel processing system design and control. It is believed that these characteristics are not limited to metal foam supports of similar pore sizes, but are instead related to both the pore size and thermal conductivity of the metal foam support. Thus, it is anticipated that similar results can be achieved with metal foam supports having different combinations of pore size and thermal conductivity.

While particular elements, embodiments and applications of the present invention have been shown and described, it will be understood, of course, that the invention is not limited thereto since modifications may be made by those skilled in the art, particularly in light of the foregoing teachings. It is therefore contemplated that the appended claims cover such modifications as incorporate those features that come within the scope of the invention.

What is claimed is:

1. A selective oxidizer assembly consisting essentially of:
(a) a feed gas inlet for directing a feed gas comprising carbon monoxide and hydrogen into the assembly;
(b) an injector upstream of the feed gas inlet for supplying a gas stream comprising oxygen to the assembly;
(c) a catalyst bed for converting the feed gas and oxygen to a process gas, the catalyst bed comprising a selective oxidation catalyst on a metal foam support; and
(d) a process gas outlet.

2. The assembly of claim 1 wherein the metal foam support has a pore size in the range of about 10 ppi to about 40 ppi.

3. The assembly of claim 1 wherein the metal foam support has a pore size in the range of about 10 ppi to about 20 ppi.

4. The assembly of claim 1 wherein the metal foam support has a pore size in the range of about 10 ppi.

5. The assembly of claim 1 wherein the catalyst bed has a front portion and a rear portion, and the metal foam support in the front portion has a smaller pore size relative to the metal foam support in the rear portion.

6. The assembly of claim 5 wherein the metal foam support in the front portion of the catalyst bed has a pore size smaller than 10 ppi.

7. The assembly of claim 5 wherein the metal foam support in the rear portion of the catalyst bed has a pore size of about 10 ppi.

8. The assembly of claim 5 wherein the metal foam support in the front portion of the catalyst bed has a pore size in the range of about 20 ppi to about 40 ppi, and the metal foam support in the rear portion of the catalyst bed has a pore size of about 10 ppi.

9. The assembly of claim 1 wherein the catalyst bed has a first catalyst loading in a front portion of the bed that is greater than a second catalyst loading in a rear portion of the bed.

10. The assembly of claim 1 wherein the metal foam support comprises an FeCrAlY alloy.

11. The assembly of claim 1 wherein the selective oxidation catalyst comprises platinum.

12. The assembly of claim 1 wherein the gas stream comprising oxygen is air.

13. A selective oxidizer assembly consisting essentially of:
(a) a feed gas inlet for directing a feed gas comprising carbon monoxide and hydrogen into the assembly;
(b) an injector upstream of the feed gas inlet for supplying a gas stream comprising oxygen to the assembly;
(c) a catalyst bed for converting the feed gas and oxygen to a process gas, the catalyst bed comprising a selective oxidation catalyst on a metal foam support;
(d) a process gas outlet; and
(e) a precooler upstream of the injector for supplying the feed gas to the feed gas inlet at a temperature at or above an ignition temperature of the catalyst.

14. A method of selectively oxidizing carbon monoxide to carbon dioxide, the method comprising:
(a) supplying a feed gas comprising carbon monoxide and hydrogen to an assembly consisting essentially of
a feed gas inlet for receiving the fuel gas,
an injector upstream of the feed gas inlet,
a catalyst bed comprising a selective oxidation catalyst on a metal foam support, and
a process gas outlet; and
(b) supplying a gas stream comprising oxygen to the injector.
